(19) United States
(12) Patent Application Publication
(10) Pub. No.: US 2026/0145691 A1
(43) Pub. Date: May 28, 2026

(54) SYSTEMS AND METHODS FOR VEHICLE OPERATION EVALUATION AND REPORTING

(71) Applicant: HUAWEI TECHNOLOGIES CO., LTD., Shenzhen (CN)

(72) Inventors: Wei ZHOU, Kanata (CA); Wenshu LUO, Kanata (CA); Sachi Mizobuchi, Kanata (CA); Sixuan WU, Kanata (CA); Zixuan HU, Kanata (CA); Guo Qing HUAI, Kanata (CA); Wei LI, Kanata (CA); Zhenyi HE, Shenzhen (CN)

(21) Appl. No.: 19/403,640

(22) Filed: Nov. 28, 2025

Related U.S. Application Data
(63) Continuation of application No. PCT/CN2023/097933, filed on Jun. 2, 2023.

(51) Int. Cl. B60W 50/00; B60W 50/14

(52) U.S. Cl. CPC B60W 50/0098; B60W 50/14; B60W 2050/146

(57) ABSTRACT

A computer-implemented method and system for vehicle operation evaluation and reporting are provided. A risk score indicative of a probability of a vehicular accident for a set of indicators is estimated. The set of indicators including speed, following distance, and lane deviation. A probability of a vehicular accident for the set of indicators when combined is estimated.

### CROSS-REFERENCE TO RELATED APPLICATIONS

The present application is a continuation of PCT Application No. PCT/CN2023/097933, filed on Jun. 2, 2023, the contents which are incorporated herein by reference.

### TECHNICAL FIELD

The present disclosure relates to vehicles, and, in particular, to systems and methods for vehicle operation evaluation and reporting.

### BACKGROUND

Vehicle safety through careful operation has always been a strong concern. 66% of traffic fatalities are caused by aggressive driving, per SafeMotorist.com. For vehicle operators in fatal crashes in 2019, these were the most common driver-related factors: speeding (16.6%), impairment (fatigue, alcohol, illness, etc.) (15.1%), failure to yield the right-of-way (8.4%), careless driving (6.6%), and distraction or inattention (6.3%) (Source: FMCSA, 2021).

One approach to enhancing vehicle operation safety has been to provide driving quality reports to users after each trip. Many insurance and gig economy companies encourage drivers to use a driving quality app.

Metrics collected by such driving quality mobile device applications (alternatively referred to herein as “apps”) are also useful to researchers to better understand the relationship between vehicle operation safety and various factors. There are a number of apps which provide drivers information regarding the quality of their vehicle operation. Such apps can report driving statistics, dangerous driving events, and general save vehicle operation scores to the drivers and insurance companies.

### SUMMARY

In a first aspect of the present disclosure, there is provided a computer-implemented method for vehicle operation evaluation and reporting, comprising: estimating a risk score indicative of a probability of a vehicular accident for a set of indicators, the set of indicators including speed, following distance, and lane deviation; and estimating a probability of a vehicular accident for the set of indicators when combined.

In some or all examples of the first aspect, the method further includes receiving a baseline probability of a vehicular accident based on statistical data aggregated across a group of drivers.

In some or all examples of the first aspect, the set of indicators includes acceleration.

In some or all examples of the first aspect, the probability of a vehicular accident is estimated using a machine learning model.

In some or all examples of the first aspect, the machine learning model is the Noisy-OR model.

In some or all examples of the first aspect, a time to collision is calculated by dividing the following distance by the speed.

In some or all examples of the first aspect, a probability, P(a), of a vehicular accident for each of the set of indicators is estimated using a Poisson distribution as follows:

$$P ( a ) = 1 - {e}^{- mr} ,$$

wherein r is the average crash rate per unit time period or per unit distance, and m is the risk multiplier.

In some or all examples of the first aspect, an ideal region is determined for each of the set of indicators, wherein a distance is determined between a point representative of the set of indicators and the ideal region in Cartesian space, and wherein the probability of a vehicular accident is estimated based on the distance between the point and the ideal region.

In some or all examples of the first aspect, the method further includes calculating an energy efficiency score based on a mean of acceleration over a trip.

In some or all examples of the first aspect, the method further includes calculating a comfort score based on a mean of magnitudes of changes in acceleration over a trip.

In some or all examples of the first aspect, the method further includes displaying, on a display, a risk score indicative of the probability of a vehicular accident in real-time during a trip.

In some or all examples of the first aspect, the method further includes displaying, on a display, the risk score for one or more of the indicators in real-time during a trip.

In some or all examples of the first aspect, the method further includes: analyzing the risk scores for one or more of the indicators for a trip; generating one or more messages corresponding to the risk scores for the one or more of the indicators and a set of message templates; and displaying the one or more messages on a display.

In some or all examples of the first aspect, instance risk scores are calculated for portions of a trip, and wherein a map of the trip is presented on a display, the map identifying the portions of the trip for which high risk scores were calculated with markers.

In some or all examples of the first aspect, instance risk scores are calculated for portions of a trip, and wherein a map of the trip is presented on a display, the map identifying the portions of the trip for which high risk scores were calculated with a variance in a color of the trip identified on the map.

In some or all examples of the first aspect, video data captured during the trip is presented concurrently with a map showing at least a portion of a trip route and a location of a vehicle along the trip route corresponding to the video data being concurrently displayed, wherein a control is presented, the control enabling user selection of a time during a trip, and wherein selection of a time during the trip using the control causes the location on the map to be updated to reflect the position of the vehicle at the selected time.

In some or all examples of the first aspect, video data captured during the trip is presented concurrently with a graph showing at least one indicator associated with a probability of a vehicular accident for a corresponding time interval of the trip, wherein a control is presented, the control enabling user selection of a time during a trip, and wherein selection of a time during the trip using the control causes the time interval for which the at least one indicator is shown in the graph to be adjusted for the selected time.

In some or all examples of the first aspect, a map is presented concurrently with the video data, the map showing at least a portion of a trip route and a location of a vehicle along the trip route corresponding to the video data being concurrently displayed, and wherein selection of the time during the trip using the control causes the location on the map to be updated to reflect the position of the vehicle at the selected time.

In accordance with a second aspect of the present disclosure, there is provided a vehicle operation evaluation and reporting system, comprising: one or more processors; and memory storing instructions that, when executed by the one or more processors, cause the one or more processors to: estimate a risk score indicative of a probability of a vehicular accident for a set of indicators, the set of indicators including speed, following distance, and lane deviation; and estimate a probability of a vehicular accident for the set of indicators when combined.

In some or all examples of the second aspect, the instructions, when executed by the one or more processors, cause the one or more processors to receive a baseline probability of a vehicular accident based on statistical data aggregated across a group of drivers.

In some or all examples of the second aspect, the set of indicators includes acceleration.

In some or all examples of the second aspect, the probability of a vehicular accident is estimated using a machine learning model.

In some or all examples of the second aspect, the machine learning model is the Noisy-OR model.

In some or all examples of the second aspect, a time to collision is calculated by dividing the following distance by the speed.

In some or all examples of the second aspect, a probability, P(a), of a vehicular accident for each of the set of indicators is estimated using a Poisson distribution as follows:

$$P ( a ) = 1 - {e}^{- mr} ,$$

wherein r is the average crash rate per unit time period or per unit distance, and m is the risk multiplier.

In some or all examples of the second aspect, an ideal region is determined for each of the set of indicators, wherein a distance is determined between a point representative of the set of indicators and the ideal region in Cartesian space, and wherein the probability of a vehicular accident is estimated based on the distance between the point and the ideal region.

In some or all examples of the second aspect, the instructions, when executed by the one or more processors, cause the one or more processors to calculate an energy efficiency score based on a mean of acceleration over a trip.

In some or all examples of the second aspect, the instructions, when executed by the one or more processors, cause the one or more processors to calculate a comfort score based on a mean of magnitudes of changes in acceleration over a trip.

In some or all examples of the second aspect, the instructions, when executed by the one or more processors, cause the one or more processors to display, on a display, a risk score indicative of the probability of a vehicular accident in real-time during a trip.

In some or all examples of the second aspect, the instructions, when executed by the one or more processors, cause the one or more processors to display, on a display, the risk score for one or more of the indicators in real-time during a trip.

In some or all examples of the second aspect, the instructions, when executed by the one or more processors, cause the one or more processors to: analyze the risk scores for one or more of the indicators for a trip; generate one or more messages corresponding to the risk scores for the one or more of the indicators and a set of message templates; and display the one or more messages on a display.

In some or all examples of the second aspect, instance risk scores are calculated for portions of a trip, and wherein a map of the trip is presented on a display, the map identifying the portions of the trip for which high risk scores were calculated with markers.

In some or all examples of the second aspect, instance risk scores are calculated for portions of a trip, and wherein a map of the trip is presented on a display, the map identifying the portions of the trip for which high risk scores were calculated with a variance in a color of the trip identified on the map.

In some or all examples of the second aspect, video data captured during the trip is presented concurrently with a map showing at least a portion of a trip route and a location of a vehicle along the trip route corresponding to the video data being concurrently displayed, wherein a control is presented, the control enabling user selection of a time during a trip, and wherein selection of a time during the trip using the control causes the location on the map to be updated to reflect the position of the vehicle at the selected time.

In some or all examples of the second aspect, video data captured during the trip is presented concurrently with a graph showing at least one indicator associated with a probability of a vehicular accident for a corresponding time interval of the trip, wherein a control is presented, the control enabling user selection of a time during a trip, and wherein selection of a time during the trip using the control causes the time interval for which the at least one indicator is shown in the graph to be adjusted for the selected time.

In some or all examples of the second aspect, a map is presented concurrently with the video data, the map showing at least a portion of a trip route and a location of a vehicle along the trip route corresponding to the video data being concurrently displayed, and wherein selection of the time during the trip using the control causes the location on the map to be updated to reflect the position of the vehicle at the selected time.

Other aspects and features of the present disclosure will become apparent to those of ordinary skill in the art upon review of the following description of specific implementations of the application in conjunction with the accompanying figures.

### BRIEF DESCRIPTION OF THE DRAWINGS

Reference will now be made, by way of example, to the accompanying drawings which show example embodiments of the present application, and in which:

FIG. 1A is a schematic diagram illustrating a system for vehicle operation evaluation and reporting system in accordance with example embodiments described herein.

FIG. 1B is a schematic diagram showing various physical and logical components of a user interface device of the vehicle operation evaluation and reporting system of FIG. 1A in accordance with example embodiments described herein.

FIG. 1C is a schematic diagram showing various physical and logical components of a data server system of the vehicle operation evaluation and reporting system of FIG. 1A in accordance with example embodiments described herein.

FIGS. 2A and 2B are flowcharts of a general method of vehicle operation evaluation and reporting carried out by the vehicle operation evaluation and reporting system of FIG. 1A in accordance with example embodiments described herein.

FIG. 3 shows various data reported to the vehicle operator by the vehicle operation evaluation and reporting system of FIG. 1A in accordance with example embodiments.

FIG. 4 shows an individual driver's risk curves based on Maycock et al., 1998 and Quimby et al., 1999a, 1999b.

FIG. 5A is a flowchart of a general method of vehicle operation evaluation in accordance with some embodiments described herein.

FIG. 5B shows a current value of a set of indicators mapped relative to an ideal range of the indicators.

FIG. 6 shows a general method of calculating driving energy efficiency and driving jerk in accordance with some embodiments described herein, and graphs of energy efficiency and comfort scores relative to the mean acceleration and mean jerk, respectively.

FIG. 7 shows an example image of the output presented on the display of the user interface device of FIGS. 1A and 1B in accordance with some example embodiments described herein.

FIG. 8 is a flowchart of the general method of generating insight messages in accordance with some example embodiments.

FIG. 9 shows an exemplary set of insight messages generated using the method of FIG. 8.

FIG. 10 shows the general method for extracting high risk events from a trip performed by the vehicle operation evaluation and reporting system in accordance with some example embodiments described herein.

FIG. 11 shows the method of color-coding segments of a driven road extracted using the method of FIG. 10 in accordance with some example embodiments described herein.

FIG. 12 shows visualized map prepared using the method of FIG. 10 and the method of FIG. 11 in accordance with some exemplary embodiments described herein.

FIG. 13 shows an exemplary GUI of the driving report generated by the vehicle operation evaluation and reporting app on the user interface device of FIGS. 1A and 1B in accordance with some exemplary embodiments described herein.

FIG. 14 shows a general method for generating a synchronized view as shown in FIG. 13 on the user interface device of FIGS. 1A and 1B in accordance with some exemplary embodiments described herein.

FIG. 15 shows a general method for route recommendation using driving score data in accordance with some exemplary embodiments.

FIG. 16 shows an exemplary GUI showing a route recommendation selected using the method of FIG. 15.

FIG. 17 shows a general method for predicting road driving quality score drop and alerting the driver in accordance with some exemplary embodiments.

FIG. 18 shows an exemplary GUI showing predicted road driving quality score generated using the method of FIG. 17.

FIG. 19 shows a general method for prompting a driver to take a break in accordance with some exemplary embodiments.

FIG. 20 shows an exemplary GUI showing a prompt to take a break generated using the method of FIG. 19.

FIG. 21 shows a general method for customized driving goal setting in accordance with some exemplary embodiments.

FIGS. 22A and 22B show an exemplary GUI showing the setting of driving goals and notifications upon meeting driving goals generated using the method of FIG. 21, respectively.

Similar reference numerals may have been used in different figures to denote similar components. Unless otherwise specifically noted, articles depicted in the drawings are not necessarily drawn to scale.

### DETAILED DESCRIPTION

The present disclosure is made with reference to the accompanying drawings, in which embodiments are shown. However, many different embodiments may be used, and thus the description should not be construed as limited to the embodiments set forth herein. Rather, these embodiments are provided so that this application will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although such functions are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except wherein indicated otherwise either explicitly or inherently by context.

Disclosed herein are various aspects of a vehicle operation evaluation and reporting system that provides feedback to a vehicle operator about the quality of their vehicle operation, as well as providing insight as to how the quality of their vehicle operation was determined.

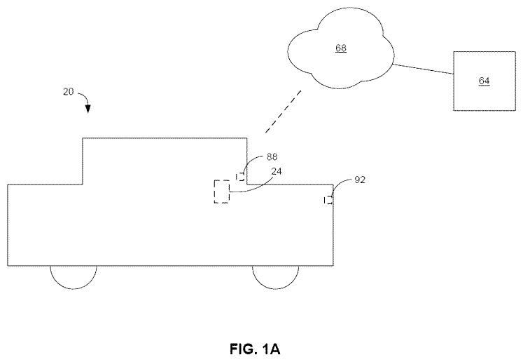

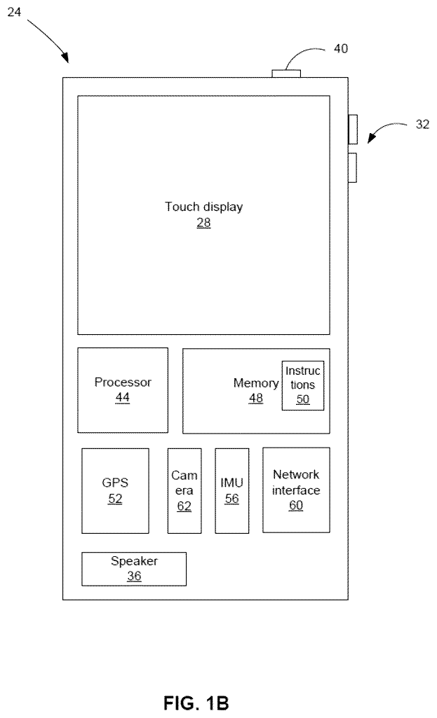

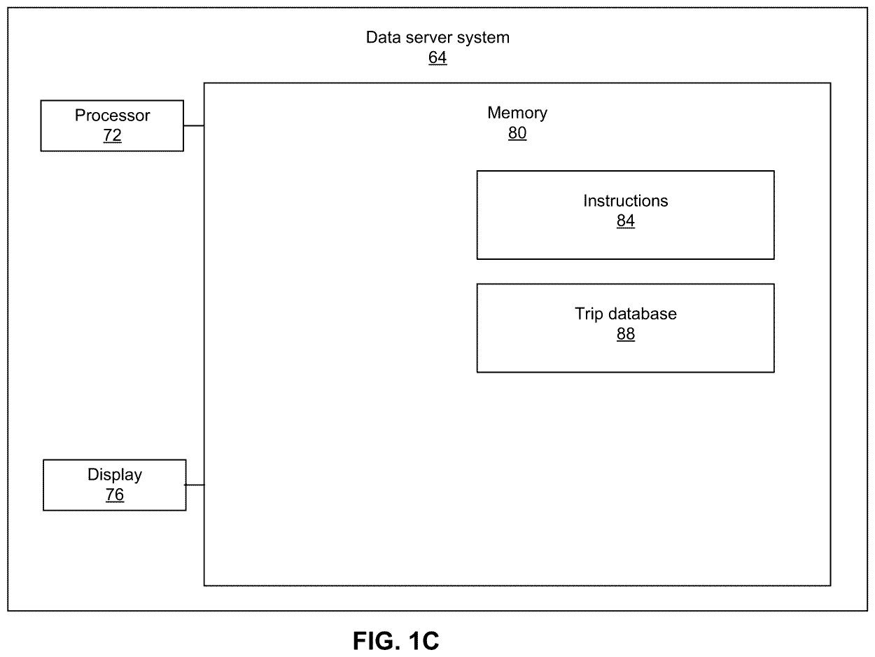

FIGS. 1A to 1C show an exemplary configuration of a vehicle operation evaluation and reporting system for a vehicle 20. The vehicle 20 can be any type of road or other surface vehicle, such as a car, truck, bus, transport truck, etc. As the examples provide pertain to the operation of road-based vehicles, the term “driver” may be used in place of the term “vehicle operator” herein. In alternative embodiments, the vehicle 20 can be a boat, an aircraft, or any other vehicle 20 that is at least partially operated by a human.

The vehicle operation evaluation and reporting system includes a user interface device 24. Although an example embodiment of the user interface device 24 is shown and discussed below, other embodiments may be used to implement examples disclosed herein, which may include components different from those shown. Although FIG. 1B shows a single instance of each component of the user interface device 24, there may be multiple instances of each component shown. In some embodiments, the user interface device 24 is a mobile device, such as a smart phone with a touch display 28 that serves as both a user output interface (i.e., display) and a user input interface (via touch). The user input interface can also include a set of controls such as hardware buttons or dials 32, a microphone, or any other suitable means for receiving input from a user. The output interface can include a display, an audio speaker 36, a light 40, or any other suitable means for outputting data and/or information to a user. The user interface device 24 includes one or more processors 44, such as a central processing unit, a microprocessor, an application-specific integrated circuit (ASIC), a field-programmable gate array (FPGA), a dedicated logic circuitry, a tensor processing unit, a neural processing unit, a dedicated artificial intelligence processing unit, or combinations thereof. The one or more processors 44 may collectively be referred to as a processor 44. The user interface device 24 includes one or more memories 48 (collectively referred to as “memory 48”), which may include a volatile or non-volatile memory (e.g., a flash memory, a random access memory (RAM), and/or a read-only memory (ROM)). The non-transitory memory 48 may store machine-executable instructions for execution by the processor 44. A set of machine-executable instructions 50 defining a vehicle operation evaluation and reporting application (or, alternatively, app) is shown stored in the memory 48, which may be executed by the processor 44 to perform the steps of the methods for providing vehicle operation quality training and using the audio-visual transformation network 20 to generate visual images from audio data and generating visual data from audio data described herein. The memory 48 may include other machine-executable instructions for execution by the processor 44, such as machine-executable instructions for implementing an operating system and other applications or functions.

In some examples, the user interface device 24 may also include one or more electronic storage units (not shown), such as a solid state drive, a hard disk drive, a magnetic disk drive and/or an optical disk drive. In some examples, one or more datasets and/or modules may be provided by an external memory (e.g., an external drive in wired or wireless communication with the user interface device 24) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 48 to implement data storage, retrieval, and caching functions of the user interface device 24.

A global positioning system (GPS) module 52 is configured to determine a geographic location of the user interface device 24 via signals received from a set of GPS satellites. An inertial measurement unit (IMU) 56 is configured to report the force, angular rate, and the orientation of the user interface device 24. A network interface 60 enables communication of the user interface device 24 with a data server system 64 via a data communications network 68. In the illustrated embodiment, the network interface 60 communicates with the data communications network 68 via cellular data communications, but, in other embodiments, can communicate via any other suitable wired or wireless communications means with data the communications network 68. The data communications network 68 can be any suitable data communications network and can include, for example, the Internet.

A camera 62 enables capturing/registration of one or more images or a stream of images in compressed or uncompressed format, and includes at least a lens array and imaging sensor on the rear side of the user interface device 24. A front-side lens array and imaging sensor can also be provided.

The components of the user interface device 24 may communicate with each other via a bus, for example. In other embodiments, the user interface device can be secured to the vehicle.

In other embodiments, the user interface device 24 can connect to one or more separate devices (or example, vehicle systems) to receive GPS data, motion data, and to output information to the user, such as via an external display and speakers of the vehicle.

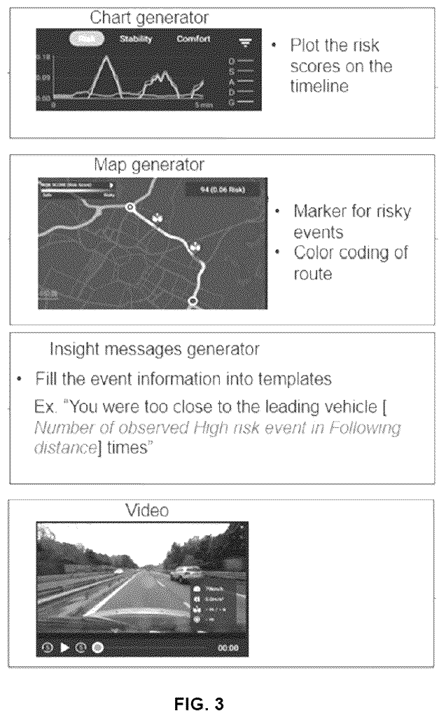

FIG. 1C shows various physical and logical components of an exemplary data server system 64 in accordance with an embodiment of the present disclosure. Although an example embodiment of the data server system 64 is shown and discussed below, other embodiments may be used to implement examples disclosed herein, which may include components different from those shown. Although FIG. 3 shows a single instance of each component of the data server system 64, there may be multiple instances of each component shown.

The data server system 64 includes one or more processors 72, such as a central processing unit, a microprocessor, an application-specific integrated circuit (ASIC), a field-programmable gate array (FPGA), a dedicated logic circuitry, a tensor processing unit, a neural processing unit, a dedicated artificial intelligence processing unit, or combinations thereof. The one or more processors 72 may collectively be referred to as a processor 72. The data server system 64 may include a display 76 for outputting data and/or information in some applications, but may not in some other applications.

The data server system 64 includes one or more memories 80 (collectively referred to as “memory 80”), which may include a volatile or non-volatile memory (e.g., a flash memory, a random access memory (RAM), and/or a read-only memory (ROM)). The non-transitory memory 80 may store machine-executable instructions for execution by the processor 72. A set of machine-executable instructions 8 defining a vehicle operation evaluation and reporting app (described herein) is shown stored in the memory 80, which may be executed by the processor 72 to perform the steps of the methods for vehicle operation evaluation and reporting described herein. The memory 80 may include other machine-executable instructions for execution by the processor 72, such as machine-executable instructions for implementing an operating system and other applications or functions.

The memory 80 stores user historical trip and related evaluation score data, as well as any associated video data, in a trip database 88.

In some examples, the data server system 64 may also include one or more electronic storage units (not shown), such as a solid state drive, a hard disk drive, a magnetic disk drive and/or an optical disk drive. In some examples, one or more datasets and/or modules may be provided by an external memory (e.g., an external drive in wired or wireless communication with the data server system 64) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 80 to implement data storage, retrieval, and caching functions of the data server system 64.

The components of the data server system 64 may communicate with each other via a bus, for example. In some embodiments, the data server system 64 is a distributed computing system and may include multiple computing devices in communication with each other over a network, as well as optionally one or more additional components. The various operations described herein may be performed by different computing devices of a distributed system in some embodiments. In some embodiments, the data server system 64 is a virtual machine provided by a cloud computing platform.

The user interface device 24 also communicates with an imaging device 88 for capturing images. The imaging device 88 can be oriented and secured to the vehicle 20 to capture images of the environment in front of the vehicle 20 in some embodiments, but can be oriented to capture images of the environment towards a lateral side or rear of the vehicle 20 in other embodiments. In other embodiments, the imaging device can capture images that span 360 degrees around the vehicle 20. The imaging device 88 can be a video camera, a photo camera, or any other suitable device for capturing a set of images. The user interface device 24 can communicate with the imaging device 88 via any suitable means such as a wired or wireless connection. In alternative embodiments, the user interface device 24 can be secured so that the camera 62 of the user interface device 24 can be used to capture images.

In addition, the user interface device 24 can communicate with a light detection and ranging (LIDAR) sensor 92 to receive LIDAR data. The LIDAR sensor 92 can be any type of suitable device for capturing data via LIDAR.

The user interface device 24 receives speed data from a data interface of the vehicle 20. Alternatively, the user interface device 24 can determine speed using one or more internal modules such as the GPS module 52, the IMU 56, in some cases in combination with LIDAR data from the LIDAR sensor 92 and/or video data from the imaging device 88.

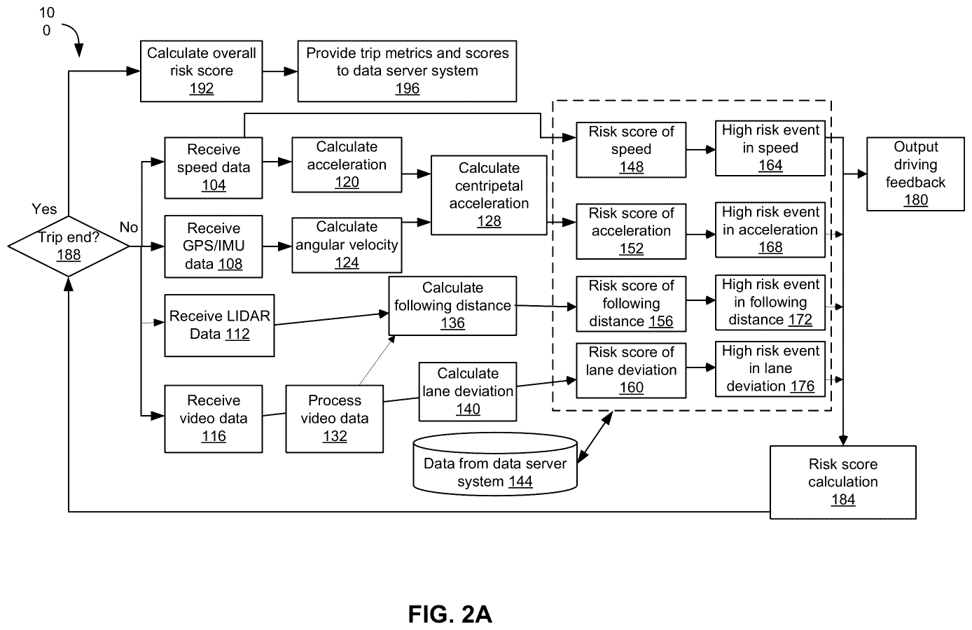

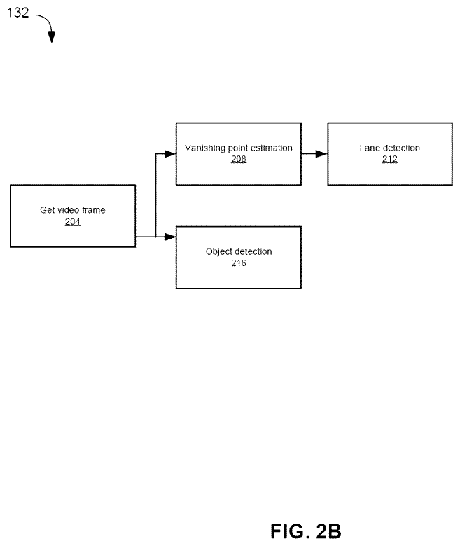

Now with reference to FIGS. 2A and 2B, a method 100 of vehicle operation evaluation and reporting in accordance with an exemplary embodiment is shown.

During operation of the vehicle, speed data is received by the vehicle operation evaluation and reporting app from the vehicle 20 (104). GPS and IMU data are received from the GPS module 52 and the IMU 56 respectively (108). The GPS data indicates the geolocation of the vehicle 20, and the IMU data indicates angular acceleration and orientation of the user interface device 24. LIDAR data is received by the vehicle operation evaluation and reporting app from the LIDAR sensor 92 (112). LIDAR data is continually being generated during operation of the vehicle and provides information about objects and surfaces in the vicinity of the vehicle 20. Video data is received by the vehicle operation evaluation and reporting app from the imaging device 88 (116).

The vehicle operation evaluation and reporting app calculates acceleration (and deceleration corresponding to negative acceleration) (120). This can be done, for example, using data received from the vehicle 20, the acceleration reported by the IMU 56 of the user interface device 24, etc. Using the IMU data received at 108, the vehicle operation evaluation and reporting app calculates angular velocity (124). Using the acceleration calculated at 120 and the angular velocity calculated at 124, the vehicle operation evaluation and reporting app calculates centripetal acceleration (128).

The video data received at 116 is processed by the vehicle operation evaluation and reporting app (132). During processing of the video data, a video frame is received within the video data (204). The video frame is processed to estimation the vanishing point (208). Using the vanishing point, the image is processed to detect lanes (212). In addition, the image is processed to detect objects, such as buildings, vehicles, bicycles, pedestrians, etc. (216). Object detection can be enhanced by processing a sequence of video frames to determine object movement relative to other objects in a scene to determine size and distance of the object in a particular video frame.

Using the objects detected in the video frame at 216 and/or the LIDAR frame at 112, together with the lanes detected at 212, a following distance is calculated by the vehicle operation evaluation and reporting app (136). The following distance is the distance between the vehicle 20 and another vehicle ahead of the vehicle 20 in the same lane or lanes. Alternatively, object detection can be performed using LIDAR data from the LIDAR sensor 92 and correlated with the lane detection performed using the video data at 212 to calculate following distance. In another alternative configuration, the position and size of an object can be used to estimate the distance of the object. In addition, a lane deviation factor is calculated by the vehicle operation evaluation and reporting app (140). The lane deviation factor is determined using the lane detection performed at 212 and based on how close the vehicle 20 is to center of a lane in which the vehicle 20 is deemed to be travelling.

The vehicle operation evaluation and reporting app is in communication with the data server system 44 to retrieve cross-driver vehicle operation risk data (144). The cross-driver vehicle operation risk data provides a baseline risk of an accident per unit distance driven or per unit time driven. Further, the cross-driver vehicle operation risk data provides the risk of accidents as a function of each of speed, acceleration, following distance, and lane deviation. This cross-driver vehicle operation disk data can be based on data collected across a set of vehicles using the vehicle operation evaluation and reporting system, or can be retrieved from other sources. In addition, the cross-driver vehicle operation risk data provides a threshold for each factor to identify high risk events. These thresholds may be universal and independent of where a vehicle is being operated, or may be conditional based on the driving environment of the vehicle. For example, the vehicle operation evaluation and reporting app may receive speed limit data for a road upon which the vehicle is travelling and may use a threshold defining high risk speed that is determined based on the speed limit.

Using the cross-driver vehicle operation and risk data retrieved from the data server system 44, the vehicle operation evaluation and reporting app determines a risk score of the speed received at 104 (148). The risk score is indicative of the probability of an accident based on the speed of the vehicle alone. In addition, the risk score of acceleration is determined using the acceleration calculated at 120 and the centripetal acceleration calculated at 128 (152). The risk score is indicative of the probability of an accident based on the acceleration of the vehicle alone. Excessive acceleration or deceleration can indicate unpredictable driving, aggressive turning, excessive braking, etc. Further, the risk score of following distance is determined using the following distance calculated at 136 (156). The risk score is indicative of the probability of an accident based on the following distance of the vehicle alone. The risk score of lane deviation is determined using the lane deviation factor calculated at 140 (160). The risk score is indicative of the probability of an accident based on the lane deviation factor of the vehicle alone. During the operation of the vehicle, the vehicle operation evaluation and reporting app logs the data collected, including the GPS geolocation, the speed, the acceleration, the following distance, and the lane deviation factor, as well as the risk scores associated with each of these data.

By monitoring the risk score of speed determined at 148, the risk score of acceleration determined at 152, the risk score of following distance determined at 156, and the risk score of lane deviation determined at 160, and using the thresholds received at 144, the vehicle operation evaluation and reporting app identifies high risk events due to speed (164), high risk events due to acceleration (168), high risk events due to following distance (172), and high risk events due to lane deviation (176). For example, if the speed meets or exceeds the speed threshold for identifying high risk events, a high risk event is deemed to be occurring. Similarly, a high risk event can be deemed to be occurring if the vehicle accelerates or decelerates too quickly, turns or stops turning too quickly, is following an object in the same lane(s) too closely, or deviates from the center of the lane without changing lanes, and/or with other vehicles and/or objects adjacent to the vehicle.

Upon detecting a high risk speed event, a high risk acceleration event, a high risk following distance event, or a high risk lane deviation event at 164, 168, 172, or 176 respectively, the vehicle operation evaluation and reporting app registers the event, together with the time, the geolocation (from GPS), and a video sequence leading up to, during, and subsequent to the event.

When a high risk event is determined to be occurring, or determined to have occurred, the vehicle operation evaluation and reporting app outputs driving feedback based on the type of high risk event.

Using the data collected (that is the risks scores for the speed, acceleration, following distance, and lane deviation), the vehicle operation evaluation and reporting app maintains and updates a risk score calculation for a trip being taken by the vehicle 20, as will be discussed below (184). It is then determined if the trip has ended (188). For example, if the vehicle 20 is shut off via the ignition, the trip is deemed to have ended. If the trip has not ended, speed data, GPS/IMU data, LIDAR data, and video data is continually collected at 104, 108, 112, and 116 respectively. If, instead, it is determined that the trip has ended, the vehicle operation evaluation and reporting app calculates an overall risk score (192). The overall risk score is a combination of the risk scores for speed, acceleration, following distance, and lane deviation determined at 148, 152, 156, and 160 respectively. The vehicle operation evaluation and reporting app then provides trip metrics and scores to the data server system 44 (196). Here, data for each score over the entire trip is provided by the vehicle operation evaluation and reporting app. In addition, the vehicle operation evaluation and reporting app may also transfer some or all of the video data to the data server system 44 as well for later review. This data transfer to the data server system 44 may be selectively be delayed until a Wi-Fi connection is detected to reduce consumption of valuable mobile data amounts.

FIG. 3 shows various data that is reported to the vehicle operator by the vehicle operation evaluation and reporting app. A chart generator generates a graph of the risk score during the trip. A map generator presents a map of the trip and indicates the location(s) of any high risk events. An insight messages panel presents text alerts summarizing the trip, such as noting how many high risk events were deemed to have occurred. A video player enables playback of the video captured during the trip.

The vehicle operation evaluation and reporting app uses different inputs and calculates vehicle operation quality scores (which includes a crash risk score, a vehicle operation energy efficiency score and a vehicle operation comfort score), and presents a visual report of the vehicle operation quality information.

For vehicles with an autonomous mode (i.e., autopilot) or semi-autonomous mode (such as cruise control, lane assist, or assisted braking or steering to avoid objects), the vehicle operation evaluation and reporting app can determine the forced autopilot disengagement time and frequency.

In determining the relationship between the probability of an accident and each of velocity, acceleration, following distance, and lane deviation, a baseline risk can be acquired from statistical information of road safety (for example, the average driver has x % chance of getting into a car accident per year). This statistical information can be industry-wide, from a single organization, or aggregated across a group of organizations.

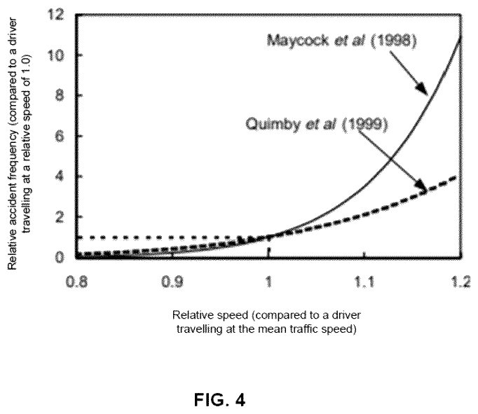

Some driving behavior is considered to induce higher accident risk. For instance, previous research showed that drivers who habitually travel faster than average are involved in more accidents in a year's driving. FIG. 4 shows an individual driver's risk curves based on Maycock et al., 1998 and Quimby et al., 1999a, 1999b. The relationship between the risk factor and the relative values of individual factors are determined from statistical summaries of large sample populations.

In some embodiments, the system can calculate the relative risk based on each of the current driving indicators at 148, 152, 156, and 160 in the method 100 of FIG. 2A using a Poisson distribution to estimate the probability of occurrence of accidents. That is, the crash probability P(a) is calculated as

$$P ( a ) = 1 - {e}^{- mr} ,$$

where r is the average crash rate per unit time period or per unit distance, and m is the risk multiplier.

Then, the risk scores for each of the indicators are fused together to generate the probability of an accident at 184 in the method 100 of FIG. 2A. In some embodiments, the risk scores for each of the indicators are fused together using a Noisy-OR model. The crash probability is estimated based on the current vehicle speed, time to collision (calculated using following distance divided by speed), and lane deviation. This probability of an accident as a function of vehicle speed, following distance, and lane deviation is passed by the data server system 44 or may be pre-provisioned to the vehicle operation evaluation and reporting app and updated as required.

In some embodiments, driving performance metrics (for example, speed, following distance, and lane deviation) can be considered in combination instead of individually, such as is performed at 184 in the method 100 of FIGS. 2A and 2B. Further, these driving performance metrics can be evaluated considering vehicle operation factors, such as, for example, the type of road, the degree of congestion, etc. For instance, an appropriate speed will differ between local streets and highway, and slower speed is required for safety when the following distance is shorter.

In order to assign a vehicle operation score, both current and overall for a trip, the system sets a “desired performance zone” in the space consists of multiple dimensions, and assess the current driving performance based on the distance from the desired zone. It allows the system to access driving quality more flexibly, adapting dynamically to changing driving conditions.

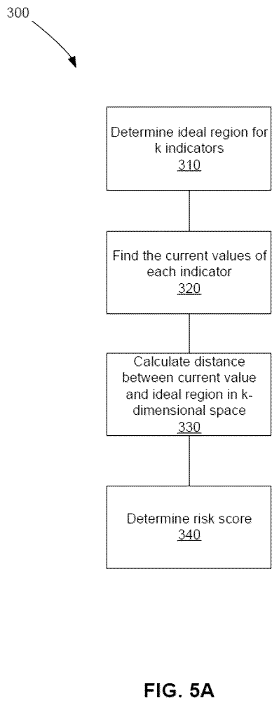

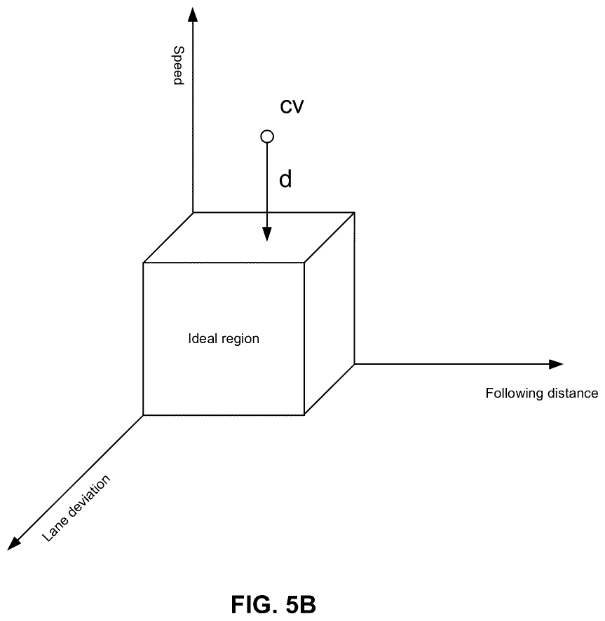

FIG. 5A shows a general method 300 of vehicle operation evaluation in accordance with some embodiments. The method 300 starts with the determination of an ideal region for k indicators (310). In one embodiment, the ideal region is defined, in effect, independently for each of the k factors. FIG. 5B shows such an ideal region defined for three indicators, speed, following distance, and lane deviation. A lower and upper limit for each of speed, the following distance, and a lane deviation factor is set. The lane deviation factor can be determined in any suitable manner, such as by a square of the distance of the vehicle from the center of the lane at any instance (that is, for the current value), and an average of the square of the distance of the vehicle from the center of the lane over the entire trip for a trip metric.

Next, the current values of each indicator are determined (320). A current value cv is indicated on the Cartesian graph of Cartesian space shown in FIG. 5B. Then, the distance d between the current value cv and the ideal range is determined (330). The shortest distance d between the current value cv and the ideal region is determined. A risk score is then determined based on the distance d (340). The quality of vehicle operation factor is related to the distance d, so that higher values denote higher risk scores.

As will be appreciated, the method 300 of FIG. 5A can be employed to determine a risk score at 184 in the method 100 of FIG. 2A. Further, the Cartesian graph presented in FIG. 5B may be presented by the vehicle operation evaluation and reporting app at 180 in the method 100 of FIG. 2A.

Other distances can be used between the ideal region for the indicators and the actual metrics being registered as a measure of the driving risk score. For example, the risk score can be inversely related to the greatest distance for any one indicator. That is,

$${d}_{Chebyshev} ( p , q ) = {max}_{i} ( \vert {p}_{i} - {q}_{i} \vert ) ,$$

where p is a vector of the actual metrics for the indicators and q is a vector of the corresponding limits for the indicators in the ideal region. In still another example, the risk score can be inversely related to the Manhattan distance between the actual metrics and the ideal region of the indicators. That is,

$${d}_{1} ( p , q ) = {‖ p - q ‖}_{1} = {\sum }_{i = 1}^{n} \vert {p}_{i} - {q}_{i} \vert ,$$

where p is a vector of the actual metrics for the indicators and q is a vector of the corresponding limits for the indicators in the ideal region.

In some embodiments, a stability score can also be calculated. Driving stability is the amount of movement change of a vehicle, which includes change in acceleration, as well as changes in the rate of acceleration (jerk). It can be an important factor of vehicle operation quality because it affects comfort and energy consumption.

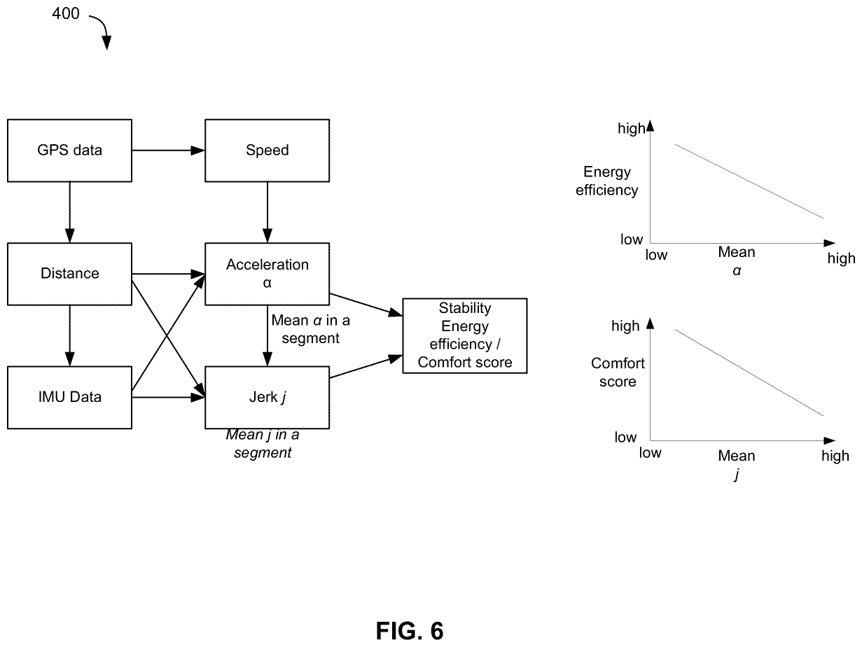

A method 400 of calculating energy efficiency as a mean acceleration per trip segment and driving jerk as a mean jerk per trip segment in accordance with some embodiments is shown in FIG. 6. Driving stability is a measure of the smoothness of the trip(s) and is measured using both acceleration/deceleration (corresponding to energy efficiency) and changes in acceleration/deceleration (corresponding to jerk). By reducing the amount of acceleration and deceleration, the energy efficiency of the vehicle can be increased. Further, by increasing the energy efficiency and reducing the amount of jerk, passenger comfort can be increased. A trip segment is generated based on the travelling distance. For example, trip segments of a general size, such as 100 meters, can be chosen. Alternatively, trips can be segmented into n equal parts.

Energy consumption can be calculated as the work done, W, by the vehicle's power system on the distance traveled (displacement) s, so that it is directly proportional to the cumulative acceleration (a)

$$W = \int Fds = \int mads = m \int ads ,$$

where F is force to move an object of mass m. Thus, when the speed changes are small, the energy consumption is small. This is especially true when the vehicle, such as a transport truck) is carrying a large load.

Further, passenger comfort can be calculated as a function of acceleration and change in acceleration (that is, jerk). Jerk is defined as the time derivative of the longitudinal vehicle acceleration.

GPS data is used to determine a distance travelled. The speed of the vehicle can be obtained from the vehicle and used to calculate acceleration. Alternatively, the acceleration can be obtained from the IMU. The determined acceleration can be used to calculate a mean acceleration a over a segment to provide an energy efficiency score. As the mean acceleration a increases, the energy efficiency score decreases. Further, changes in acceleration (that is jerk j, the absolute value to ensure positive and negative changes do not cancel each other out) over the segment are calculated and averaged over the segment to provide a comfort score. As the mean jerk j increases, the comfort score decreases. As will be readily understood, these energy efficiency and comfort scores both impact energy efficiency of the vehicle.

The vehicle operation evaluation and reporting app can report the energy efficiency score and the comfort score in the same manner as other scores.

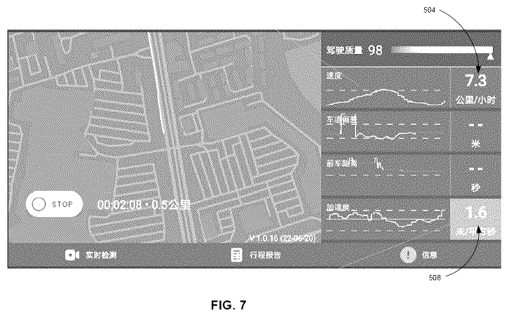

The calculated vehicle operation scores (including risk score, energy efficiency score, and comfort score) can be shown to the user concurrently in graphical chart(s) while driving. FIG. 7 shows an example image of the output presented on the display of the user interface device 24 by the vehicle operation evaluation and reporting app. In this way, users (i.e., drivers) can monitor how their driving behavior impacts the score 504 immediately, which is expected to encourage the users to adjust their driving to reduce the risk. As can be seen, line graphs of each score are presented to the user, with the ability for the user to view the corresponding video from the trip. This enables review of the trip and any high risk events identified, as well as visualization of how the user's scores progressed during the trip. When the user performs a high risk action while driving, the corresponding vehicle operation evaluation factor user interface 508 turns red to provide a visible notification.

After a trip is completed, the calculated scores can be used by the vehicle operation evaluation and reporting app to generate insight messages, which includes advice to the user to improve their vehicle operation quality (i.e., lower the risk, and raise the energy efficiency and comfort scores).

By using the probability-based risk score, the vehicle operation evaluation and reporting system can provide drivers relative risk information such as “With your current driving speed tendency, your crash risk par year is 2 times higher than the same age group”. It is expected to be more intuitive and easy to interpret to action than just providing information such as “You are speeding too much”, “Your current driving score is 60”.

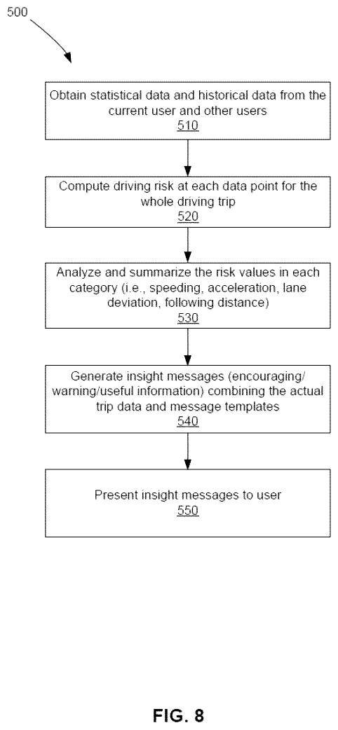

FIG. 8 illustrates the general method 500 of generating insight messages in accordance with some embodiments. The method 500 begins with the obtaining of statistical data and historical data for the current user and other users (510). The data server system 44 retrieves the data stored for the user from previous trips and for other users. The driving risk at each point is calculated for the entire trip just concluded (520). The statistical and/or historical data is used for calculating risk scores. The risk score calculation relies on both the statistical average risk and the current driving status. The statistical information can be also more specifically obtained for more specific situations, like for specific road, time, or other traffic/environmental conditions. The risk scores (i.e., speed, acceleration, lane deviation, and following distance) are analyzed and summarized by the data server system 44 (530). Then, upon analysis of the scores for the recently completed trip, the data server system 44 generates insight messages by combining actual trip data and message templates (540). The insight messages are then transmitted to the vehicle operation evaluation and reporting app, which then presents the insight messages to the user on the display (550).

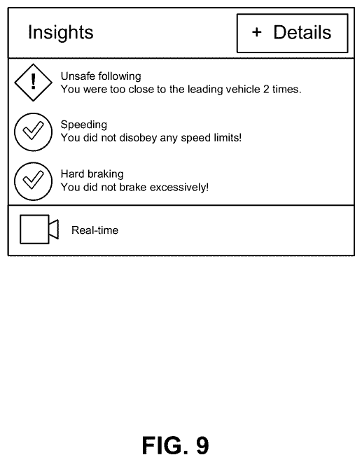

FIG. 9 shows an exemplary set of insight messages generated using the method 500 of FIG. 8.

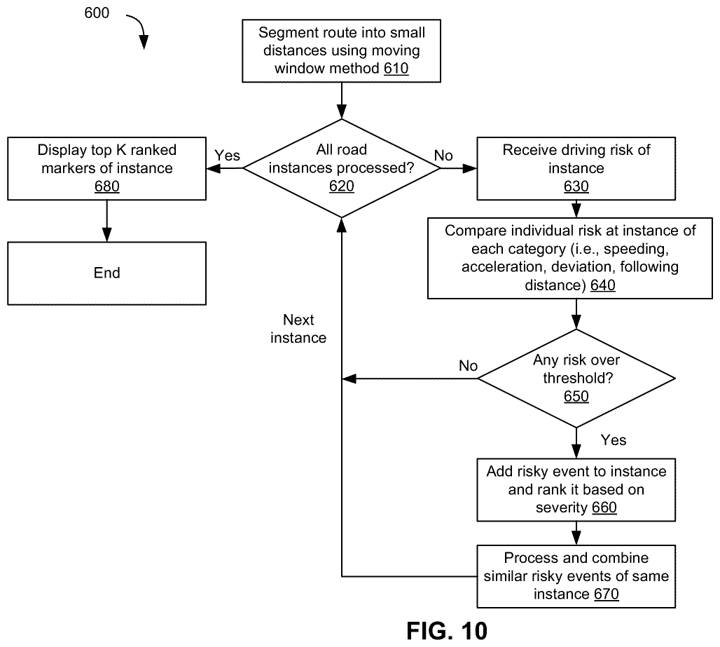

FIG. 10 shows the general method 600 to extract high risk events from a trip performed by the vehicle operation evaluation and reporting system in accordance with some embodiments. The route of a trip is segmented into small distances using the moving window method (610). It is then determined at 620 if all road instances have been processed. If there are remaining road instances to be processed, a driving risk for the instance is received (630). The driving risk for the instance may be based on data collected by the vehicle operation evaluation and reporting system or may be retrieved from another source. The risk scores for the user are then compared to those received for the instance (640). In particular the risk scores for speed, acceleration, lane deviation, and following distance are compared to the driving risk received for the instance. If any of the user's risk scores are determined to be over a threshold relative to the driving risk for the instance at 650, the instance is deemed to include a high risk event that is ranked based on the severity of the surpassing of the threshold (660). Similar high risk events of the same instance are processed and combined (670), after which the next road instance is selected at 620. Once all road instances are processed, the top K ranked markers of the instance are displayed (680), after which the method 600 ends.

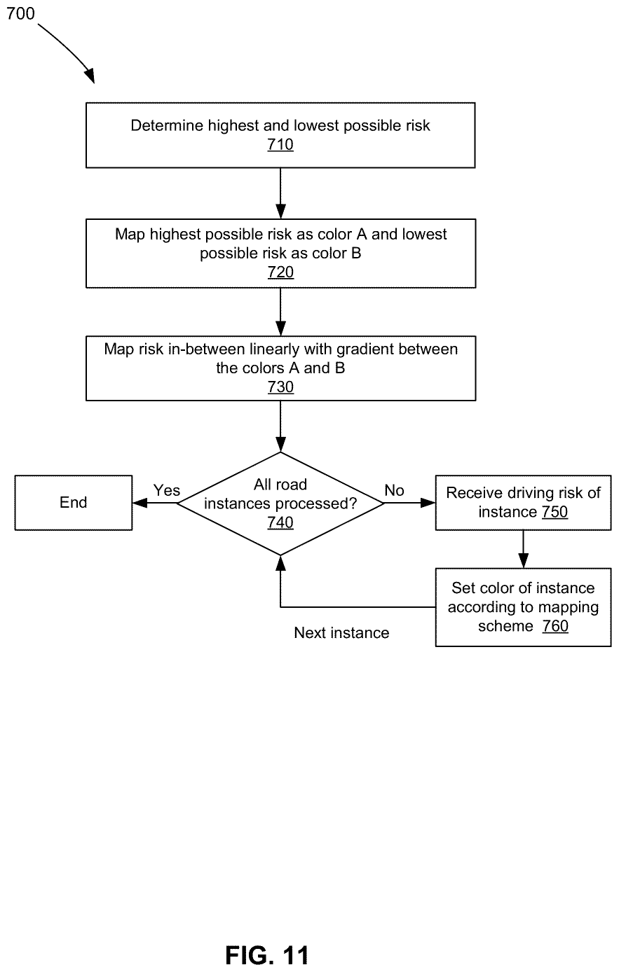

FIG. 11 shows the method 700 of color-coding segments of a driven road in accordance with some embodiments. The method 700 commences with the determination of the highest and lowest possible risk scores for the segment (710). The highest possible risk score is mapped to color A, and the lowest possible risk score is mapped to color B (720). Risk scores in between the highest possible risk score and the lowest possible risk score are mapped linearly with gradient between the colors A and B (730). It is then determined at 740 whether all road instances are processed. A driving risk score of an instance is received (750). The color of the instance is set according to the mapping scheme determined at 730 (760), after which it is determined whether there are remaining unprocessed instances at 740. Upon processing all road instances, the method 700 ends.

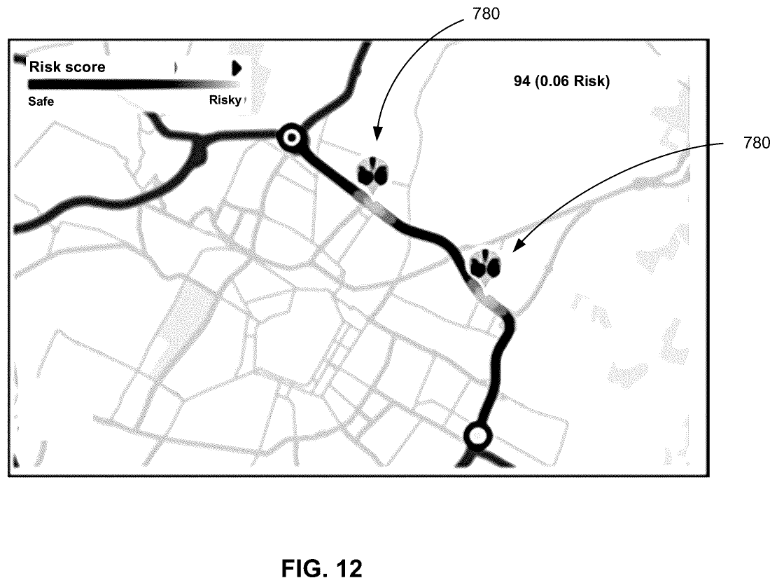

FIG. 12 shows a visualized map prepared using the method 600 of FIG. 10 and the method 700 of FIG. 11. The depicted route is shown in a heavier weight line. Two instances 780 having relatively higher risk scores are marked with a correspondingly different gradient of the colors representing the highest and lowest risk scores.

The score chart, visualized events and colored level of scores by segment, insights and the recorded video can be shown together as a driving report for each trip after driving, in a manner of synchronized view, so that the user can review their driving from different aspects.

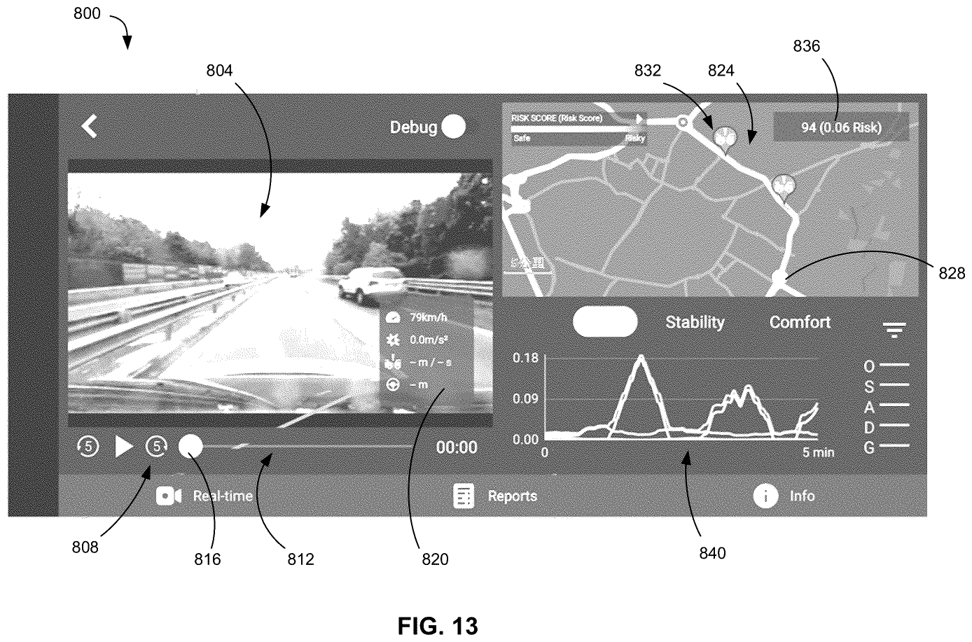

FIG. 13 shows an exemplary graphical user interface (GUI) 800 of the driving report generated by the vehicle operation evaluation and reporting app on the user interface device 24. The GUI 800 includes a set of panels to display data and images captured and/or calculated during a trip. In particular, a video panel 804 presents video data captured by an imaging device, such as imaging device 88 shown in FIG. 1A. The imaging device captures video data during the course of a trip, the video data including a set of sequential images or data representing the set of sequential images, such as I-frames, P-frames, and B-frames that can be used to reconstruct a set of visual images captured by the imaging device. Each of the visual images is associated with a specific time at which the video data corresponding to the visual image is captured.

The video panel 804 includes a set of playback controls 808 to enable control of playback of video of a trip. The playback controls 808 include a play button, skip forward and backward buttons, and a timeline 812 representative of the time period during which a trip occurred. As will be appreciated, the scale of the time line is adjusted based on the duration of the trip. A video cursor 816 enables manual video scrubbing backwards and forwards along the timeline 812. A translucent information overlay 820 overlaid atop of the video images presents the recorded speed, longitudinal acceleration (speeding up and/or slowing down), following distance, and lateral acceleration from cornering synchronized with the video images being shown.

A map panel 824 presents a scaled map showing the trip route taken and a map cursor 828 corresponding to the location along the trip route at the time the video image being presented in the video panel 804 was captured. High risk event markers 832 indicate the location of high risk events along the trip route. A translucent risk score overlay 836 is overlaid on the map in the map panel 824, and presents either the risk score corresponding to the position in the trip or for the entire trip.

A chart panel 840 presents graphs of the speed, lateral acceleration, following distance, and lateral acceleration during a time interval of the trip. Magnitude for each indicator extends along the vertical axis, and time extends along the horizontal axis. In the presently illustrated view, the time interval is five minutes, but this time interval can be selected in any manner desired. Where the trip is sufficiently short, graph can represent the data for the entire trip. The time interval of the trip shown in the chart panel 840 corresponds with the position of the video cursor 816 along the timeline 812. As will be appreciated, the chart in the chart panel 840 can be centered on the time selected by the video cursor 816, can start or end with the time selected using the video cursor 816, or can be positioned in any other suitable manner based on the location of the video cursor 816.

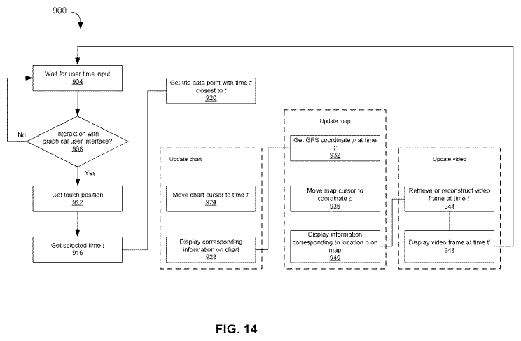

FIG. 14 shows a general method 900 for generating a synchronized view on the user interface device 24 in accordance with some embodiments. For ease of reference, the method 900 will be described with reference to the GUI 800 of FIG. 13, it will be appreciated that the same approach can be employed with other user interfaces.

The method 900 commences with waiting for user time input (904). User time input corresponds to a selection of a position along the timeline 812, a movement of the video cursor 816, a selection along the trip route in the map panel 824, or a selection of a time along the graphs in the graph panel 840. If it is determined that touch input is received on the timeline 812 of the video panel 804, the trip route on the map panel 824, or the graph in the graph panel 840 at 908, the touch position is obtained (912). When a user touches along the timeline 812 or touches and drags the video cursor 816 on the touch screen of the device, the position of the video cursor 816 is changed. The selected time/corresponding to the input is obtained (916). For example, if the video cursor 816 is dragged forward or backward, or if the timeline 812 is touched, resulting in the video cursor 816 moving to that position, a particular time along the trip represented by the position along the timeline 812 of the video cursor 816 is determined. The time is determined based on the position along the timeline 812 and the pro-rata time of the trip. Where a position on the graph in the graph panel 840 is touched, the time corresponding to the region of the graph touched is determined. Where a position along the trip route is touched in the map panel 824, the time at which the vehicle was at that position is determined. The trip data point with time t closest to time/is obtained (920). The trip can be broken down into a set of granular points in a number of methods. The data captured and/or calculated for the trip can be summarized at a set of points distributed throughout the trip. It may be infeasible to maintain all of the data for the trip in some cases. Thus, the system may determine metrics and store data for selected times throughout the trip. The selected times can be determined in any suitable manner. The time t′ is the closest of these selected times to the actual time corresponding to where the video cursor 816 has been moved to.

Then the chart presented in the graph panel 840 is updated by moving the chart cursor to time/′ (924). Where the chart presents five minute intervals of the trip, and where the chart is centered on the time selected via the video cursor 816, the system can determine new lower and upper limits of the time interval to be shown in the chart based on a new center point t′ and the chart data corresponding to the updated time interval can be retrieved or calculated accordingly. The corresponding information is then displayed on the chart (928). The map is then updated by getting the GPS coordinate p at time/′ (932). The map cursor 828 is then moved to coordinate p (936). Information corresponding to the location p on the map is then displayed (940). Next, the video frame at time t′ is retrieved or reconstructed (944). Time t′ may correspond to an I-frame, in which case the video image is retrieved, or may correspond to a P-frame or a B-frame, in which case the video frame is reconstructed using the appropriate I-frame. The video frame at time t′ is then displayed in the video panel 804 (948), after which the method 900 returns to 904 to await further user input.

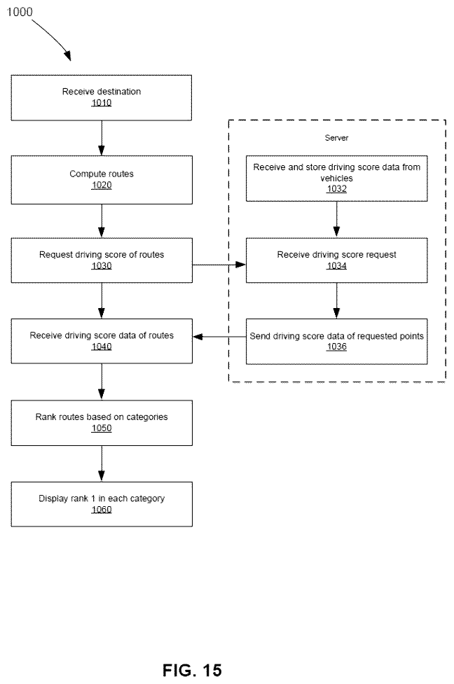

FIG. 15 shows a general method 1000 for route recommendation using driving score data in accordance with some exemplary embodiments. Calculated driving scores can be used to recommend a route that is easier to drive, based on the user's current driving skill. The recommendation can be based on both current and historical data (e.g., the score of other drivers currently on the road, or the historical score of the driver of the road).

The method 1000 begins with the receiving of a destination (1010). The destination can be received from the driver via the GUI, via a separate device, or via another system, such as a remote server providing trip destinations for taxis, etc. The system computes various candidate routes to the destination (1020). This is a regular step during trip planning and may be performed by the user interface device or by another computing device, such as a remote server. Then, the user interface device requests driving scores for the candidate routes (1030). The user interface device system communicates with the data server system to request the driving scores for the candidate routes. The data server system receives and stores driving score data from vehicles (1032). Upon receipt of the driving score request from the user interface device (1034), the data server system send the driving score data of requested points to the user interface device (1036).

Upon receipt of the driving score of the candidate routes (1040), the candidate routes are ranked based on categories (1050). The top ranked candidate route for each category is then presented by the user interface device on the display (1060).

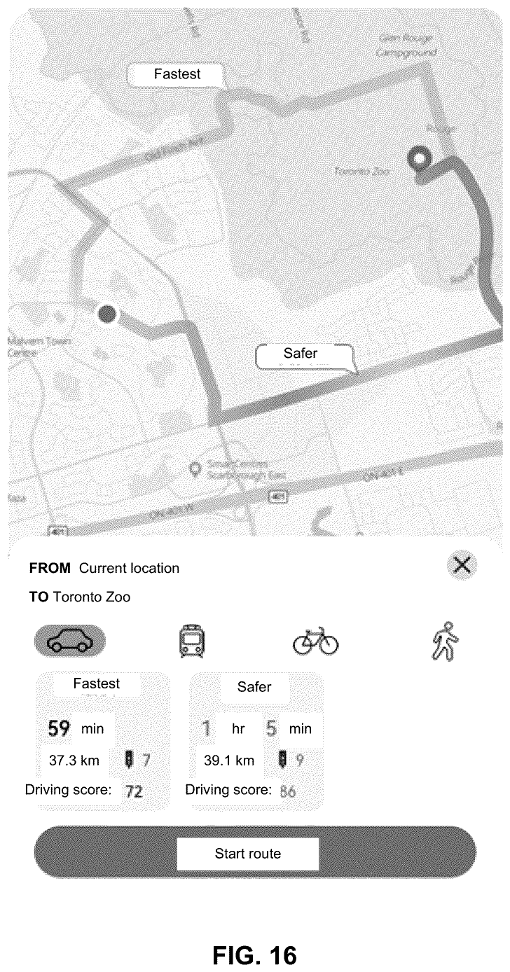

FIG. 16 shows an exemplary GUI showing two route recommendations selected for two categories using the method of FIG. 15, enabling the user to select a candidate route based on the desired category of type of route.

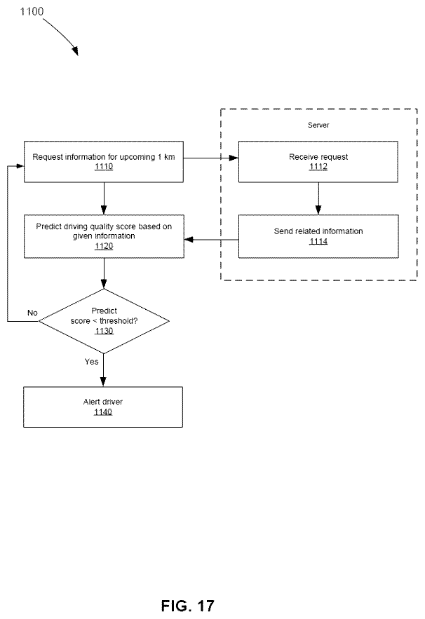

FIG. 17 shows a general method 1100 for predicting road driving quality score drop and alerting the driver in accordance with some exemplary embodiments. The method 1100 commences with the requesting of information for an upcoming portion of the route (1110). The user interface device communicates with the data server system to request and obtain this information. Upon receiving the request (1112), the data server system sends the related information to the user interface device (1114). The user interface device then predicts the driving quality score based on the given information (1120). If it is determined that the predicted score is greater than a threshold (1130), then the user interface device continues to request information and predict the driving quality score based on the returned information. If, instead, the predicted score for the next 1 km is lower than the threshold, then the user interface device alerts the driver (1140). The alert can be a visual notification, an audio notification, a haptic notification, etc.

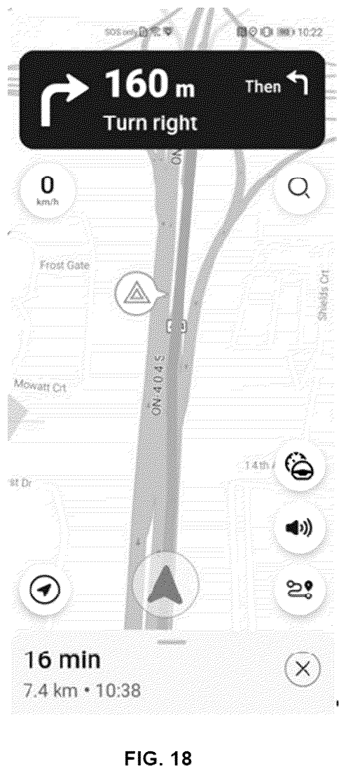

FIG. 18 shows an exemplary GUI showing predicted road driving quality score generated using the method of FIG. 17.

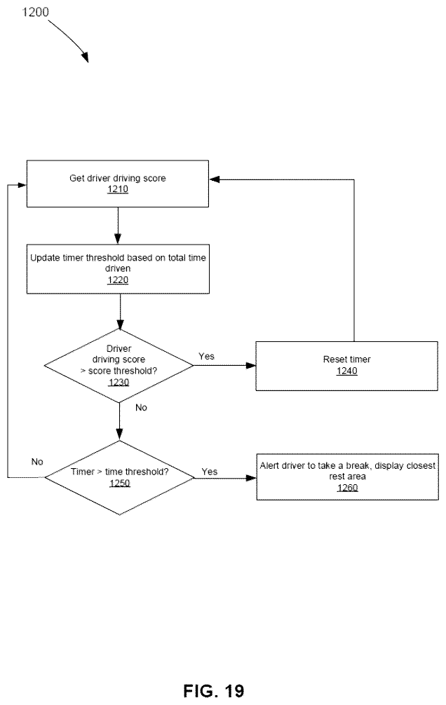

FIG. 19 shows a general method 1200 for prompting a driver to take a break in accordance with some exemplary embodiments. Driving quality score can be one factor to judge whether the driver should take a break. If the driving quality score is lower than a certain threshold continuously for a period of time, the system can alert the driver to take a break and suggest the location of the nearest resting area.

The method 1200 commences with the obtaining of the driver driving score (1210). The driver driving score is generated or retrieved periodically or in some other suitable manner. It can be an average over some time period, a weighted average, or can be determined in any other suitable manner. The timer threshold is updated based on the total time driven (1220). As the time driven increases, the timer threshold is decreased. The driver driving score is then compared to a score threshold (1230). The score threshold can be fixed, dynamic depending on the road conditions of an upcoming trip portion to be travelled, determined based as a function of the driver's ongoing driver score, etc.

If the driver driving score exceeds the score threshold, it is determined if the driving time (that is, the amount of time that the driver has been driving) exceeds a time threshold (1250). If the driving time is below the time threshold, the method 1200 returns to 1210. If instead, the driving time exceeds the time threshold, the user interface device prompts the driver to take a break, and displays the closest rest area or areas (1260). Another option can be to provide autonomous driving takeover options. More factors can be integrated into deciding the threshold, e.g. weather, road condition, driver fatigue etc. Similar to the predicted road driving quality score drop alert, a predicted driving quality score can also be compared with the threshold.

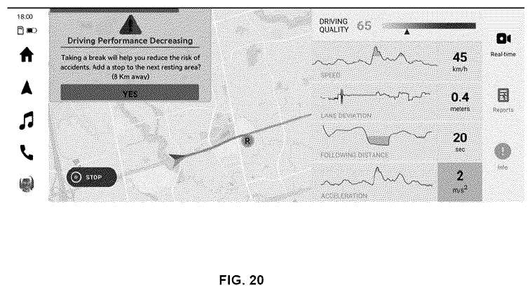

FIG. 20 shows an exemplary GUI showing a prompt to take a break generated using the method of FIG. 19. A prompt is shown, suggesting that the driver take a break from driving. In addition, a number of metrics are displayed to help the driver understand how the driver's performance is going.

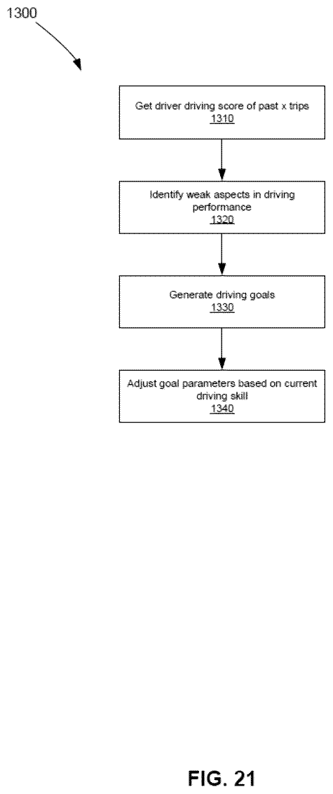

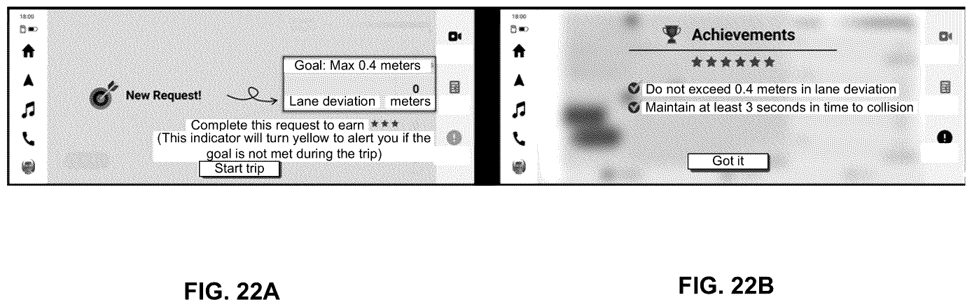

FIG. 21 shows a general method 1300 for customized driving goal setting in accordance with some exemplary embodiments. The system can encourage users to maintain high driving quality through gamification. In this method 1300, the system automatically generates driving goals based on the weakness in driver's current driving. For example, if a driver shows poor score in lane deviation (i.e., the driver tends to deviate from the lane center), then the system will generate a goal of minimizing lane deviation, the difficulty level will be set based on the driver's current skill and help to improve smoothly. The system could update goals periodically, and this goal can be presented to gamify the goal of improving their driving technique using elements like quests and achievements, as shown in FIGS. 22A and 22B.

The steps (also referred to as operations) in the flowcharts and drawings described herein are for purposes of example only. There may be many variations to these steps/operations without departing from the teachings of the present disclosure. For instance, the steps may be performed in a differing order, or steps may be added, deleted, or modified, as appropriate.

In other embodiments, the same approach described herein can be employed for other modalities.

Through the descriptions of the preceding embodiments, the present invention may be implemented by using hardware only, or by using software and a necessary universal hardware platform, or by a combination of hardware and software. The coding of software for carrying out the above-described methods described is within the scope of a person of ordinary skill in the art having regard to the present disclosure. Based on such understandings, the technical solution of the present invention may be embodied in the form of a software product. The software product may be stored in a non-volatile or non-transitory storage medium, which can be an optical storage medium, flash drive or hard disk. The software product includes a number of instructions that enable a computing device (personal computer, server, or network device) to execute the methods provided in the embodiments of the present disclosure.

All values and sub-ranges within disclosed ranges are also disclosed. Also, although the systems, devices and processes disclosed and shown herein may comprise a specific plurality of elements, the systems, devices and assemblies may be modified to comprise additional or fewer of such elements. Although several example embodiments are described herein, modifications, adaptations, and other implementations are possible. For example, substitutions, additions, or modifications may be made to the elements illustrated in the drawings, and the example methods described herein may be modified by substituting, reordering, or adding steps to the disclosed methods.

Features from one or more of the above-described embodiments may be selected to create alternate embodiments comprised of a sub-combination of features which may not be explicitly described above. In addition, features from one or more of the above-described embodiments may be selected and combined to create alternate embodiments comprised of a combination of features which may not be explicitly described above. Features suitable for such combinations and sub-combinations would be readily apparent to persons skilled in the art upon review of the present disclosure as a whole.

In addition, numerous specific details are set forth to provide a thorough understanding of the example embodiments described herein. It will, however, be understood by those of ordinary skill in the art that the example embodiments described herein may be practiced without these specific details. Furthermore, well-known methods, procedures, and elements have not been described in detail so as not to obscure the example embodiments described herein. The subject matter described herein and in the recited claims intends to cover and embrace all suitable changes in technology.

Although the present invention and its advantages have been described in detail, it should be understood that various changes, substitutions and alterations can be made herein without departing from the invention as defined by the appended claims.

The present invention may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1. A computer-implemented method for vehicle operation evaluation and reporting, comprising:
estimating a risk score indicative of a probability of a vehicular accident for a set of indicators, the set of indicators including speed, following distance, and lane deviation; and
estimating a probability of a vehicular accident for the set of indicators when combined.

2. The computer-implemented method of claim 1, further comprising:
receiving a baseline probability of a vehicular accident based on statistical data aggregated across a group of drivers.

3. The computer-implemented method of claim 1, wherein the probability of a vehicular accident is estimated using a machine learning model.

4. The computer-implemented method of claim 1, wherein a probability, P(a), of a vehicular accident for each of the set of indicators is estimated using a Poisson distribution as follows:
$$P ( a ) = 1 - {e}^{- mr} ,$$
wherein r is the average crash rate per unit time period or per unit distance, and m is a risk multiplier.

5. The computer-implemented method of claim 1, wherein an ideal region is determined for each of the set of indicators, wherein a distance is determined between a point representative of the set of indicators and the ideal region in Cartesian space, and wherein the probability of a vehicular accident is estimated based on the distance between the point and the ideal region.

6. The computer-implemented method of claim 1, further comprises at least one of:
calculating an energy efficiency score based on a mean of acceleration over a trip;
calculating a comfort score based on a mean of magnitudes of changes in acceleration over a trip;
displaying, on a display, a risk score indicative of the probability of a vehicular accident in real-time during a trip; and
displaying, on a display, the risk score for one or more of the indicators in real-time during a trip.

7. The computer-implemented method of claim 1, further comprising:
analyzing the risk scores for one or more of the indicators for a trip;
generating one or more messages corresponding to the risk scores for the one or more of the indicators and a set of message templates; and
displaying the one or more messages on a display.

8. The computer-implemented method of claim 7, wherein instance risk scores are calculated for portions of a trip, and wherein a map of the trip is presented on a display, the map identifying the portions of the trip for which high risk scores were calculated with markers.

9. The computer-implemented method of claim 1, wherein instance risk scores are calculated for portions of a trip, and wherein a map of the trip is presented on a display, the map identifying the portions of the trip for which high risk scores were calculated with a variance in a color of the trip identified on the map.

10. A vehicle operation evaluation and reporting system, comprising:
one or more processors; and
memory storing instructions that, when executed by the one or more processors, cause the one or more processors to:
estimate a risk score indicative of a probability of a vehicular accident for a set of indicators, the set of indicators including speed, following distance, and lane deviation; and
estimate a probability of a vehicular accident for the set of indicators when combined.

11. The vehicle operation evaluation and reporting system of claim 10, wherein the instructions, when executed by the one or more processors, cause the one or more processors to:
receive a baseline probability of a vehicular accident based on statistical data aggregated across a group of drivers.

12. The vehicle operation evaluation and reporting system of claim 10, wherein the probability of a vehicular accident is estimated using a machine learning model.

13. The vehicle operation evaluation and reporting system of claim 10, wherein a probability, P(a), of a vehicular accident for each of the set of indicators is estimated using a Poisson distribution as follows:
$$P ( a ) = 1 - {e}^{- mr} ,$$
wherein r is the average crash rate per unit time period or per unit distance, and m is the risk multiplier.

14. The vehicle operation evaluation and reporting system of claim 10, wherein an ideal region is determined for each of the set of indicators, wherein a distance is determined between a point representative of the set of indicators and the ideal region in Cartesian space, and wherein the probability of a vehicular accident is estimated based on the distance between the point and the ideal region.

15. The vehicle operation evaluation and reporting system of claim 10, wherein the instructions, when executed by the one or more processors, cause the one or more processors to at least one of:
calculate an energy efficiency score based on a mean of acceleration over a trip;
calculate a comfort score based on a mean of magnitudes of changes in acceleration over a trip;
display, on a display, a risk score indicative of the probability of a vehicular accident in real-time during a trip; and
display, on a display, the risk score for one or more of the indicators in real-time during a trip.

16. The vehicle operation evaluation and reporting system of claim 10, wherein instance risk scores are calculated for portions of a trip, and wherein a map of the trip is presented on a display, the map identifying the portions of the trip for which high risk scores were calculated with markers.

17. The vehicle operation evaluation and reporting system of claim 10, wherein instance risk scores are calculated for portions of a trip, and wherein a map of the trip is presented on a display, the map identifying the portions of the trip for which high risk scores were calculated with a variance in a color of the trip identified on the map.

18. The vehicle operation evaluation and reporting system of claim 10, wherein video data captured during the trip is presented concurrently with a map showing at least a portion of a trip route and a location of a vehicle along the trip route corresponding to the video data being concurrently displayed, and a graph showing at least one indicator associated with a probability of a vehicular accident for a corresponding time interval of the trip, wherein, in response to time input received via a video control, a position on the trip route, or a position on the graph, a corresponding time during the trip is determined, the video data at the corresponding time is presented, the location of the vehicle along the trip route at the corresponding time is indicated, and the time interval for which the at least one indicator is shown in the graph to be adjusted for the corresponding time.

19. A non-transitory computer readable medium including instructions to:
estimate a risk score indicative of a probability of a vehicular accident for a set of indicators, the set of indicators including speed, following distance, and lane deviation; and
estimate a probability of a vehicular accident for the set of indicators when combined.
